(19) United States
(12) Patent Application Publication
(10) Pub. No.: US 2012/0030044 A1
(43) Pub. Date: Feb. 2, 2012

(54) VIRTUAL POINT OF SALE TERMINAL AND ELECTRONIC WALLET APPARATUSES AND METHODS FOR PROCESSING SECURE WIRELESS PAYMENT TRANSACTIONS

(75) Inventor: Douglas J. HURST, Boulder, CO (US)

(73) Assignee: Mocapay, Inc., Boulder, CO (US)

(21) Appl. No.: 13/210,125

(22) Filed: Aug. 15, 2011

Related U.S. Application Data
(62) Division of application No. 12/199,567, filed on Aug. 27, 2008, now abandoned.
(60) Provisional application No. 60/968,515, filed on Aug. 28, 2007.

(51) Int. Cl. G06Q 20/32; G06Q 20/40

(52) U.S. Cl. 705/18; 705/16

(57) ABSTRACT

Apparatuses and methods for a virtual point of sale terminal and an electronic wallet are described. One embodiment is a virtual point of sale terminal for initiating and accepting a wireless electronic payment, comprising a mobile communication device configured to communicate with a payment gateway system and a point of sale processing application installed in the mobile communications device, the point of sale processing application being configured to wirelessly transmit a request for payment of a transaction to the payment gateway system and to wirelessly receive an approval code for payment of the transaction from the payment gateway system.

### PRIORITY

The present application is a divisional application of U.S. patent application Ser. No. 12/199,567, Attorney Docket No. MOCA-001/01US, filed Aug. 27, 2008, entitled “Method and System for Processing Secure Wireless Payment Transactions and for Providing a Virtual Terminal for Merchant Processing of Such Transactions,” which claims priority under 35 U.S.C. §119(e) to commonly owned and assigned U.S. Provisional Application Ser. No. 60/968,515, Attorney Docket No. MOCA-001/00US, filed Aug. 28, 2007, entitled “Method and System for Returning Purchaser Identity Parameters in Connection with a Secure Wireless Payment Transaction and for Providing a Virtual Terminal for Merchant Processing of Such Transactions,” each of which is herein incorporated by reference in its entirety and for all purposes.

### RELATED APPLICATIONS

The present application is related in subject matter to commonly owned and assigned U.S. Pat. No. 7,657,489, entitled “System and Method for Secure Wireless Payment Transactions,” which is herein incorporated by reference in its entirety, and to commonly owned and assigned U.S. Patent Application No. (unassigned), Attorney Docket No. MOCA-001/03US, filed herewith, entitled “Method and System for Verifying an Identification of a Person.”

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to using a wireless device such as a mobile phone or personal data assistance (“PDA”) to initiate and process an electronic payment transaction. The present invention relates particularly, without limitation, to methods and systems for processing secure wireless payment transactions and for providing a virtual terminal for merchant processing of such transactions.

### BACKGROUND OF THE INVENTION

Today's retailers rely on the ability to accept credit cards as a primary form of payment for goods and services. In order to have merchant services (i.e., accepting credit cards), a point of sale (“POS”) machine and terminal is used. A POS terminal can be a full-sized computer and monitor with the ability to read the magnetic strip of a credit card. Such POS terminals usually provide processing functionality such as individual cashier login, transaction tracking and reporting, supervisor override, and others. Alternatively, a POS terminal may be a smaller device with a simple keypad and limited display capabilities. A common function to all POS terminals is the need to communicate with a payment service or gateway in order to receive approval of a transaction as well as settlement instructions to receive payment. In order to communicate with a payment gateway, hardwired communication lines are used such as telephone lines or Ethernet wire. With telephone lines, a POS terminal dials into the payment gateway in order to receive an authorization or approval. This approach can be time consuming. Further, a dedicated telephone line is usually required. When an Ethernet connection is used, transactions occur over the Internet. Using Ethernet cable as a connection medium is faster than a telephone line; however, a dedicated Internet connection is required.

A downside to the above approaches is the need for a hardwired connection to the POS terminal. Thus, the POS terminal is not mobile in nature. In a mobile environment, retailers often forego or supplement brick and mortar establishments and transact business in multiple locations, including a street corner, a restaurant or a moving car. Traditional POS terminals are incapable of functioning in such an environment. Wireless POS terminals do exist, but with limitations. They are usually bulky, have a short battery life, and limited functionality. Due to a wireless POS terminal's limitations, rarely will a retailer use one in a mobile environment.

Additional limitations to both hardwired and wireless POS terminals are the costs incurred in purchasing them. From wireless handheld units to full-sized computers with POS functionality, the cost per unit can be from $200 to thousands of dollars. Hence, a system and method are needed that overcome the functional shortcomings of wireless POS terminals, provide the functionality of traditional hardwired POS terminals, while avoiding the costs of purchasing one or more terminals.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

One illustrative embodiment is a virtual point of sale terminal for initiating and accepting a wireless electronic payment, the apparatus comprising a mobile communication device having wireless data communication capabilities, the mobile communication device configured to communicate with a payment gateway system; a point of sale processing application installed onto the mobile communications device, the point of sale processing application configured to: wirelessly transmit a request for payment of a transaction to the payment gateway system; and wirelessly receive an approval code for payment of the transaction from the payment gateway system.

Another illustrative embodiment is an electronic wallet configured for initiating a wireless electronic payment, the apparatus comprising a mobile communication device having wireless data communication capabilities, the mobile communication device configured to communicate with a payment gateway system; an electronic wallet application installed onto the mobile communication device, the electronic wallet application configured to: wirelessly transmit a personal identification number to the payment gateway system; wirelessly receive a financial account summary associated with the mobile communication device from the payment gateway system; wirelessly transmit a transaction amount and a desired financial account for funding a transaction to the payment gateway system; and wirelessly receive an authorization code for the transaction from the payment gateway system.

Another illustrative embodiment is a method for wirelessly paying for a transaction from an electronic wallet of a mobile communication device, the method comprising submitting a personal identification number and a device identifier to a payment gateway system, wherein the personal identification number is associated with the mobile communication device; receiving a summary of financial accounts from the payment gateway system, wherein the summary of financial accounts is associated with the mobile communication device; submitting a selected financial account from the summary of financial accounts and a transaction amount to the payment gateway system; receiving an authorization code from the payment gateway system, wherein the authorization code is associated with a pre-approval for the transaction amount; and receiving an electronic receipt of the transaction from one of a merchant associated with the transaction and the payment gateway system.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a system diagram illustrating the components for processing electronic transactions with a virtual terminal;

FIG. 2 is a flowchart of a method for establishing a merchant account with a payment gateway;

FIG. 3 is a flowchart of a method for utilizing the functionality of a merchant virtual terminal administration website;

FIG. 4 is a flowchart of a method for establishing a customer gateway account with the payment gateway;

FIG. 5 is a flowchart of a method for making an electronic payment using a mobile device;

FIG. 6 is a system diagram of a mobile device displaying an electronic wallet summary;

FIG. 7 is a flowchart of a method used by a merchant to process a transaction using a virtual terminal;

FIG. 8 is a flowchart illustrating a method for processing and settling an electronic transaction from the point of view of the payment gateway;

FIG. 9 is a flowchart of a method for verifying the identity of a customer to an additional entity; and

FIG. 10 is a system diagram illustrating an electronic transaction processing system.

### DETAILED DESCRIPTION

In various illustrative embodiments of the invention, the problem of establishing merchant services (i.e., processing electronic payments) in a mobile environment while minimizing equipment costs is reduced by providing a virtual POS terminal to retailers. By utilizing an existing data-enabled mobile device such as the APPLE IPHONE™, retailers may transform the mobile device into a virtual point of sale terminal (“VT”) capable of processing payments similar to traditional POS terminals. The retailer may utilize the wireless communication capabilities of the device to use merchant services anywhere a wireless communication signal may be received. In one embodiment, the mobile device may be a mobile phone having WI-FI capabilities. In another embodiment, the mobile device may be equipped with EDGE, GSM or 3G data capabilities. In other words, any mobile device, whether equipped with a phone or not, capable of sending and receiving wireless data may be used as a VT. Throughout the application the terms “mobile phone”, “mobile device”, and “WI-FI equipped mobile phone” may be used interchangeably to describe any mobile device capable of sending and receiving wireless data. A POS application may be downloaded onto the mobile device to provide an interface for processing electronic transactions in any location capable of receiving a wireless communication signal.

Additionally, a consumer with a wireless data-enabled mobile phone may also purchase goods and services from a merchant capable of accepting electronic payments from both a virtual terminal or a traditional POS terminal. Further, a consumer is able to link multiple personal financial accounts to their mobile phone's electronic payment account. The consumer's mobile phone is capable of performing functions of an electronic wallet, but permitting the consumer to purchase good and services with any of their linked financial accounts. This includes using store-specific charge cards at a merchant other than the store associated with the charge card (e.g., using a MACYS™ charge card at STARBUCKS™.)

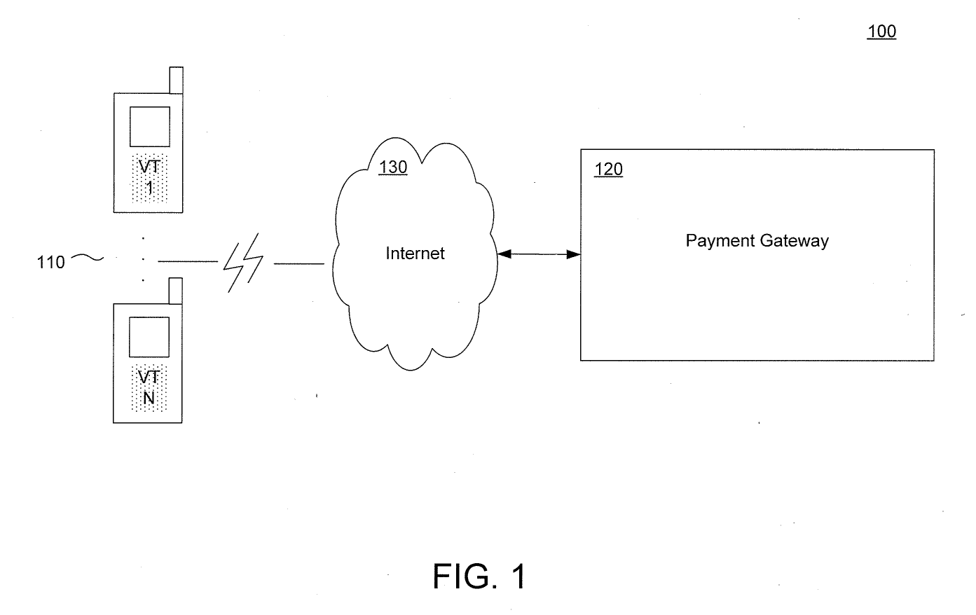

Referring now to the drawings, where like or similar elements are designated with identical reference numerals throughout the several views, and referring in particular to FIG. 1, it is a system diagram showing the basic components for wirelessly processing electronic payments. Virtual Terminals 1-N 110 are mobile devices such as mobile phones that may be associated with one or more merchants. For example, an individual may own two separate businesses. A single VT 110 may be associated with and used to process electronic payments for both businesses. Additionally, a single merchant may utilize multiple VTs 110. For example, a restaurant may have numerous wait staff, each using a VT 110 during his or her shift. Further, a single VT may be used by multiple persons, each person or cashier having a distinct cashierID. For example, if a wait staff shift ends, the VT 100 he or she used may be given to another wait staff who is just beginning a shift. Alternatively, two or more persons may use a single VT 100 simultaneously just as a multiple wait staff may share single traditional POS terminal in a restaurant. A unique cashierID may be inputted before each transaction to maintain records of who processed each transaction.

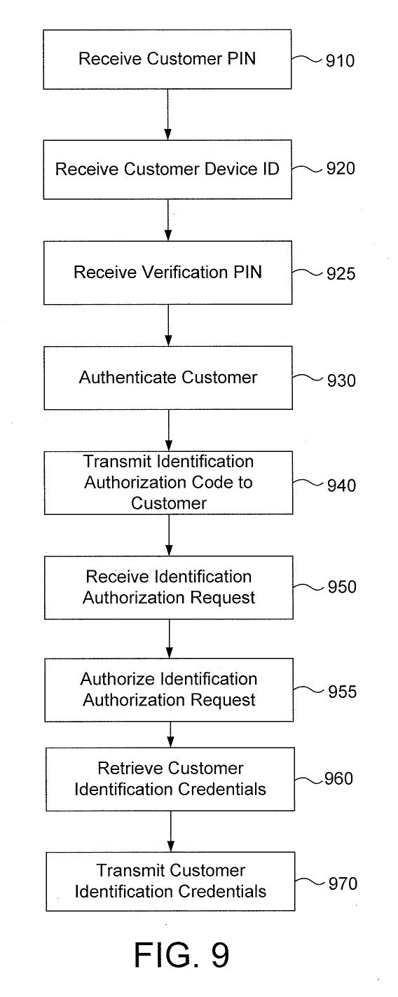

In order for a VT 100 to initiate the processing of transactions, a payment gateway 120 is used. The payment gateway 120 is a collection of one or more computer servers configured to authenticate customers and merchants, authorize transactions, and provide settlement instructions for each transaction. Each VT 110 may communicate with the payment gateway 120 through the Internet 130 by using the VT's 100 wireless communication capabilities. A detailed description of payment gateway 120 is illustrated in FIG. 9 below.

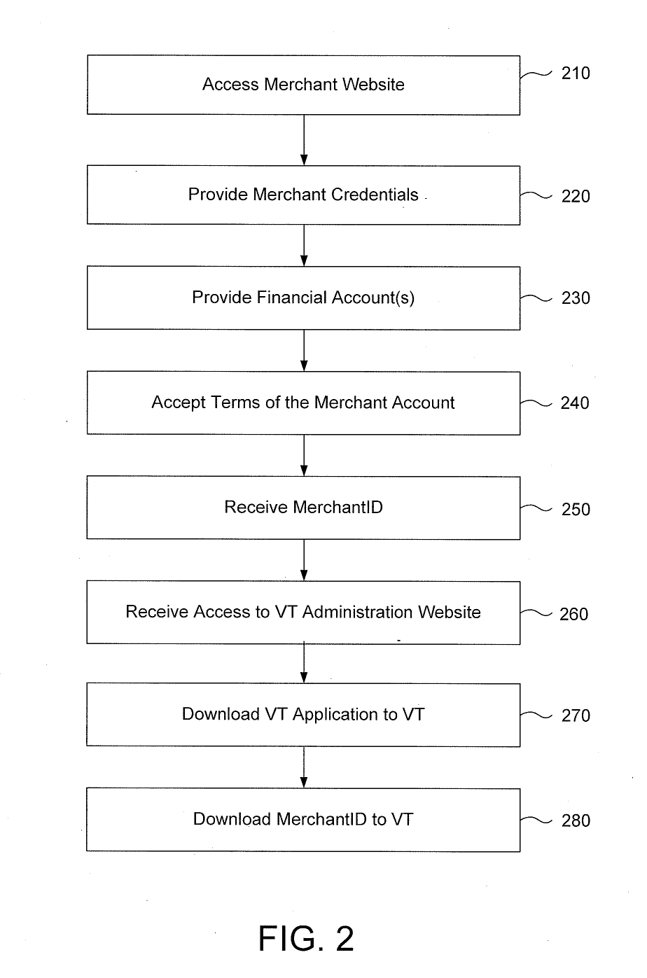

FIG. 2 is a flowchart of a method for establishing a merchant account with a payment gateway. In order to utilize wireless payment processing, a business establishes a merchant account with a payment gateway 120. First, a prospective merchant navigates to the payment gateway's merchant website (step 210) over the Internet using a web browser. Depending on the embodiment, the prospective merchant can access the payment gateway website using a computer or a wireless data-enabled mobile device such as a mobile phone or PDA. Next, the merchant's credentials are provided by the prospective merchant (step 220). In one embodiment, such credentials may include a login ID, password, business name, and address, etc. Further, the prospective merchant provides financial account information (step 230). Such information is used by the payment gateway to provide settlement instructions to an automated clearing house for transferring funds to the merchant's account. In one embodiment, a bank routing number and an account number may be provided.

In step 240, the prospective merchant accepts the terms of the merchant account. In one embodiment, such terms may include a description of transaction fees, processing fees, and additional guidelines for receiving and maintaining an account. Once the terms have been accepted, the new merchant receives a merchantID (step 250). The merchantID is a unique identifier that is associated with a single merchant. In one embodiment, the merchantID may be a random string of alphanumeric characters varying in length. In another embodiment, the merchantID may be based on one or more merchant specific strings such as business name and phone number.

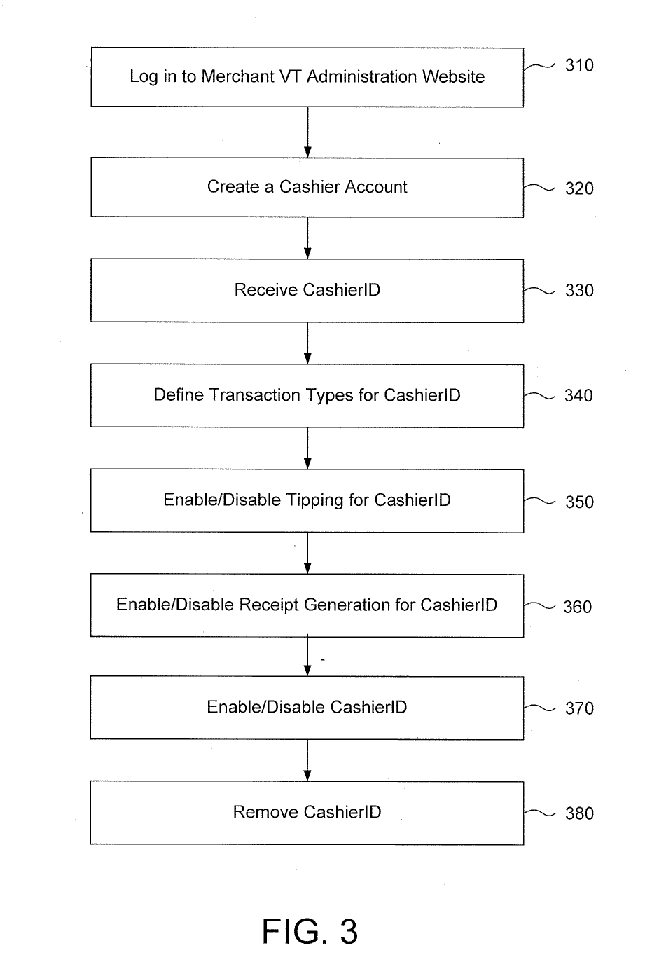

Once the new merchant has received a merchantID, they receive access to a merchant virtual terminal administration website (step 260). This website provides administrative functionality to the merchant such as creating and managing user accounts (also known as cashier accounts) and reviewing transaction history, etc. In one embodiment, the merchant administration application may be a website or a client-based software application installable on a computer or mobile device. Additional details of the merchant administration application are described in FIG. 3 below.

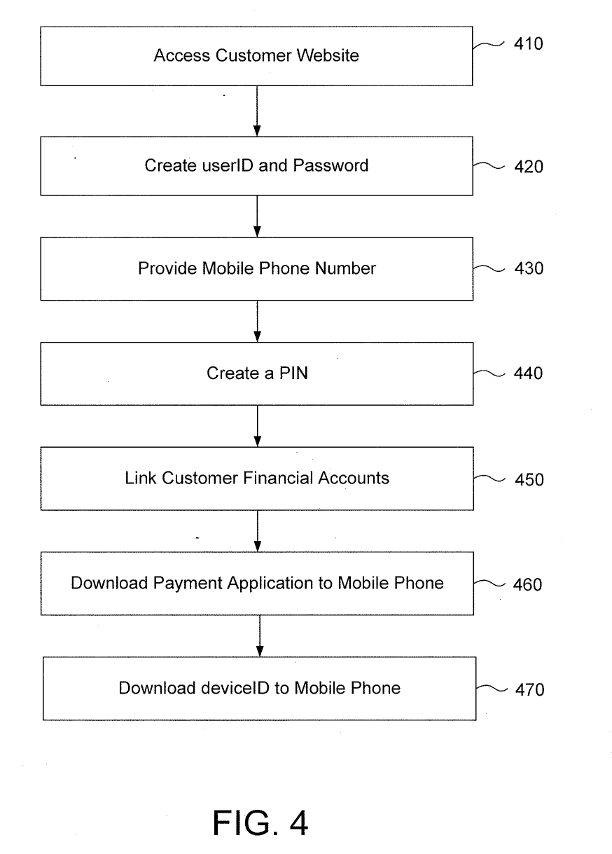

Next, the merchant downloads and installs a VT application onto one or more mobile phones (step 270). The VT application is a software application permitting the mobile phone to process electronic payments as if it were a dedicated POS terminal. Upon installation, the VT application also assigns a unique terminalID to the mobile phone. The terminalID, like the merchantID is a unique identifier used by the payment gateway to authenticate the terminal. Additional details of the VT application are further described in FIG. 4 below.

Lastly, the merchant downloads the unique merchantID to each of the mobile phones that have the VT application installed (step 280). As with the terminalID, the presence of the merchantID on each mobile phone permits the payment gateway to authentic each VT when a transaction is initiated by the merchant. In one embodiment, both the terminalID and the merchantID are encrypted binary files. Such encryption may be used to prevent unauthorized access to the identifiers.

FIG. 3 is a flowchart of a method for utilizing the functionality of the merchant virtual terminal administration website described in step 260 above. First, an authorized administrative user of a merchant may log in to the merchant VT administration website (step 310). In one embodiment, the login may be the merchantID of the merchant for which the administrative user is associated. Hence, all authorized administration users for a given merchant use the same login. In another embodiment, the login may be a unique identifier for each administrative user. Once the administrative user is logged into the application, he or she may create a cashier account (step 320). A cashier is a user who is permitted to process transactions with a VT. The administrative user inputs information relating to the cashier such as name and position. Next, a cashierID is received from the payment gateway (step 330). This identifier is unique throughout the payment gateway and is used to identify a specific cashier. In one embodiment, the cashierID is a randomly generated string of alphanumeric characters. In another embodiment, the cashierID may be a combination of relevant strings such as the merchantID and the cashier's initials. Once a cashierID is generated, a temporary password may also be created. This password may be given to the cashier upon his or her first login to a VT. In one embodiment, the password should be changed to a unique string only known by the cashier.

Once the cashier account is created, the administrative user may also define the transaction types the cashier may process (step 340). Transaction types include, but are not limited to, sale, void, credit, balance, promotion, and transaction reversal. Depending on the position or title of the cashier, the transaction types he or she may process can be different. For example, a wait staff at a restaurant might be permitted to process only sale transactions. On the other hand, the manager of the restaurant may be permitted to process voids, credits, and reversals, for example.

An administrative user may also configure a tipping option (step 350) for the cashier. As will be described in FIG. 4, it is possible for a cashier to include a customer authorized tip in a transaction initiated by a VT. Such functionality may be enabled or disabled for individual cashiers.

An administrative user may also configure an eReceipt option (step 360) for the cashier. An eReceipt is an electronically processed receipt of a transaction initiated by a VT. An eReceipt may be sent to the customer's mobile phone, via email, text message, or any other electronic communication medium known by those skilled in the art. In one embodiment, a cashier may send an eReceipt to the customer by asking for the customer's email address or mobile phone number. In another embodiment, the customer's email address or mobile phone number is forwarded to the VT by the payment gateway. Additionally, the payment gateway may send the eReceipt to the customer, thus removing the responsibility from the cashier.

Additionally, an administrative user may enable or disable the cashierID and the cashier's ability to process transactions (step 370). In other words, if a cashierID is enabled, the cashier associated with that identifier may process transactions. Alternatively, if the cashierID is disabled, the cashier cannot log in to a VT nor may he or she process any transactions. In one embodiment, a cashierID may be disabled if the user associated with the identifier is on leave or is a seasonal employee, to name just two examples.

Lastly, an administrative user may remove a cashierID (step 380). The removal of a cashierID would likely occur when the cashier associated with the identifier no longer works for the merchant.

It should be noted that the ordering of the steps described in FIG. 3 is merely an example. The order of the functions accessed in the administration application may vary without altering the scope of the invention. Further, an administrative user may only wish to access a subset of all of the functionalities described in FIG. 3.

In order for a merchant to process a transaction using a VT, the merchant's customer (“customer”) is also expected to have a gateway account with the same payment gateway. FIG. 4 is a flowchart of a method for establishing a customer gateway account with the payment gateway. First, the potential customer accesses the payment gateway customer website (step 410). Access to the website may occur using a computer or a mobile device equipped with wireless communication capabilities. Once, the potential customer has reached the website, he of she creates a unique userID and password (step 420). In one embodiment, the userID may be a combination of one ore more alphanumeric strings known by the customer. Such strings may include name, email address, or the customer's mobile phone number. The password may also be created by the customer or it may be system generated. The userID and password permit the customer to log into the payment gateway to view or change settings associated with his or her gateway account.

Next, the customer provides a mobile phone number to the payment gateway (step 430). As with a VT, the customer uses his or her mobile phone as the interface for initiating electronic transactions with a VT equipped merchant. Hence, the customer's gateway account is tied to his or her mobile phone. In one embodiment, the customer's mobile phone number may be assigned as a deviceID. As each mobile phone has a unique phone number, the deviceID associated with a mobile phone is also unique.

A customer also provides a personal identification number (“PIN”) to the payment gateway (step 440). This PIN should only be known by the customer, as the PIN is used to initiate an electronic transaction with the payment gateway. The purpose of the PIN is to create a level of security against unauthorized access to the customer's gateway account. The PIN provides similar security to an ATM PIN. Hence, an electronic transaction may not be initiated unless the customer has both possession of the mobile device associated with the account as well as knowledge of the PIN. Thus, two levels of security against unauthorized account access are provided. In other words, the PIN may only be used with the mobile device registered with the payment gateway.

Once the customer has provided the above information, one or more financial accounts are linked to his or her gateway account (step 450). In order for a customer to provide funds for an electronic transaction, at least one existing financial account must be linked to the customer's gateway account as a means for supplying the funds for the transaction. In one embodiment, a payment account may be established directly with the payment gateway, such that funds are electronically transferred into the payment account from one or more other sources. For example, funds may be transferred from an existing checking or savings account of the customer. Such transfers may be accomplished as a one-time transfer, periodic transfers (i.e. once a week), threshold transfers (i.e., once the balance drops below a pre-defined amount), or other methods known by those skilled in the art.

In another embodiment, additional types of financial accounts may be linked to the customer's gateway account. For example, a link may be created to the customer's existing checking account. In such a scenario, the customer may use the payment gateway to initiate a transaction where the funds are transferred directly from his or her checking account by way of the payment gateway. In this embodiment, the customer is not required to have funds in the payment account described above. Rather, the payment gateway acts as middle man by transferring funds from the customer's checking account to the merchant's settlement account. The end result is similar to using a checking account debit card. However, the transaction is done without physical use of a debit card.

Additionally, the customer may link other financial account types to his or her gateway account. In one embodiment, a general credit card such as VISA™, MASTERCARD™, AMERICAN EXPRESS™ OR DISCOVER™ may be linked to the gateway account. Thereafter, a customer may choose a credit card as a payment source for an electronic transaction with a merchant utilizing a VT. The payment gateway acts as a middle man by generating and executing settlement instructions with the customer's credit card and an automated clearing house. Through such settlement instructions, an automated clearing house will transfer funds from the customer's credit card account into a bank account of the merchant.

In another embodiment, a customer is able to link store specific charge cards to his or her gateway account. For example, a customer may use a MACYS™ charge card to purchase a coffee at STARBUCKS™. As with general credit cards, the payment gateway is able to charge the MACYS™ charge card and place the funds into the STARBUCKS™ settlement account. Additionally, the payment gateway may create and execute same day settlement instructions with the credit processor and other third party service providers involved in the transaction or distribution of the store-specific charge card.

In summary, a customer is able to use any personal financial account, which he or she has linked to the gateway account, to purchase goods and services without restriction as to the type of account being used (e.g., MACYS™ card used at STARBUCKS™). Additional advantages permit a customer to carry a single device (i.e., mobile phone) that is capable of utilizing all the customer's financial accounts. Thus, the customer can forego carrying a traditional wallet with a multitude of general credit cards, store specific charge cards, debit cards, etc. and carry an electronic wallet (“eWallet”) within his or her mobile phone.

Returning to FIG. 4, once the customer has linked one or more financial accounts to the gateway account, a payment application is downloaded to his or her mobile device (step 460). The payment application is used similarly to the VT application, in that the payment application permits the mobile device to communicate with the payment gateway to initiate electronic transactions. Lastly, the deviceID is downloaded to the mobile phone (step 470) as a security measure against unauthorized access of the mobile phone.

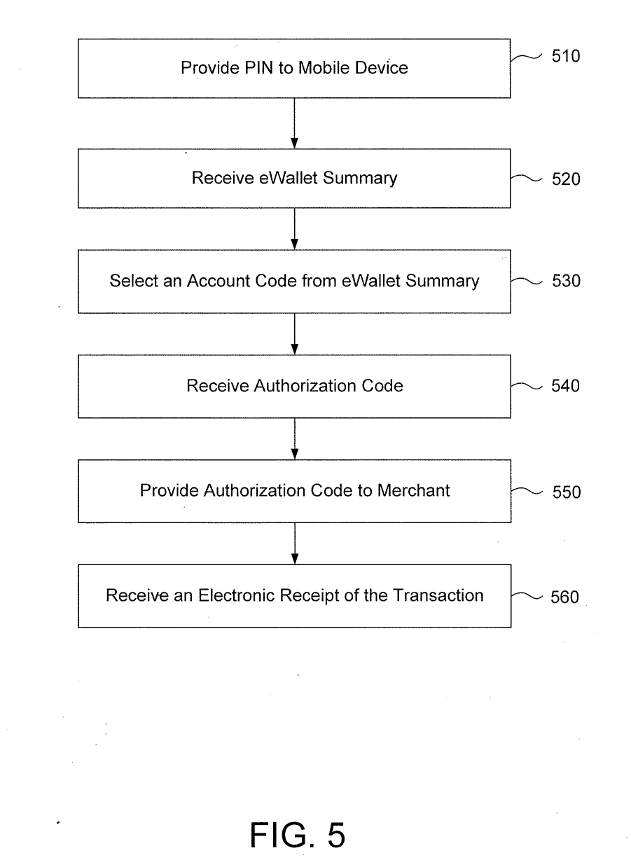

FIG. 5 is a flowchart of a method for making an electronic payment using a mobile device. First, a customer determines an amount of goods or services to purchase and inputs his or her PIN into the payment application on their mobile device (step 510). Once the PIN is entered, it is transmitted to the payment gateway by way of the wireless communication capabilities of the mobile device. In one embodiment, the PIN is transmitted by E-Mail, text message or any other transmission medium known by those skilled in the art. Momentarily, the customer receives a return transmission from the payment gateway providing a summary of the customer's eWallet (step 520).

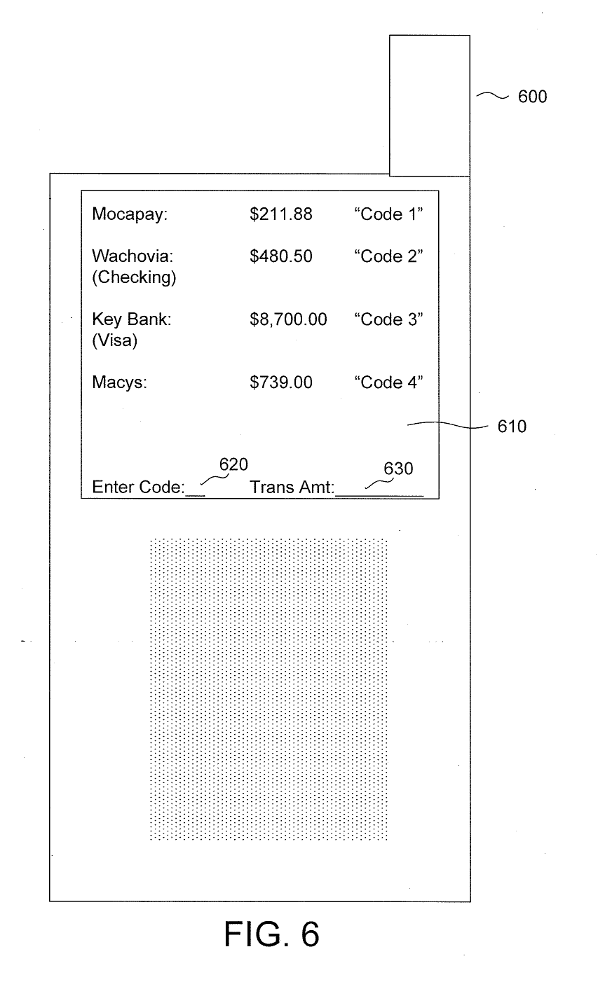

An eWallet summary is a listing of all financial accounts linked to the customer's gateway account, the balance or available credit (i.e., if an account is a credit card, the available credit is shown), and a unique account code associated with each account. An example of an eWallet summary can be seen in FIG. 6. Displayed on the mobile phone 600 is the summary message 610, along with an account code input box 620 for inputting the financial account the customer wishes to use for a transaction and a transaction amount input box 630.

Returning to FIG. 5, after the customer receives the eWallet summary 610, he or she selects an account code and a transaction amount (step 530). The account code chosen by the customer dictates which financial account will be debited for the transaction. After the customer inputs the transaction amount and account code, a one-time authorization code will be returned to the customer's mobile device (step 540). In one embodiment, the authorization code is time sensitive. In other words, the code may be valid for a limited length of time such as 15 minutes. After 15 minutes, the code is no longer valid and the transaction is canceled by the payment gateway. In another embodiment, the length of time the code remains valid may be set by the customer.

Upon receipt of the authorization code, the customer presents the code to the merchant (step 550). In one embodiment, the code may be verbally recited to the merchant. In another embodiment, the code may be wireless transmitted to the merchant's VT using a wireless data network or infrared capabilities of both mobile devices.

Once the merchant enters the authorization code and completes the transaction, the customer receives an eReceipt (step 560) of the transaction. The eReceipt is transmitted to the customer's mobile phone by way of E-Mail, text message or any other transmission medium known by those skilled in the art.

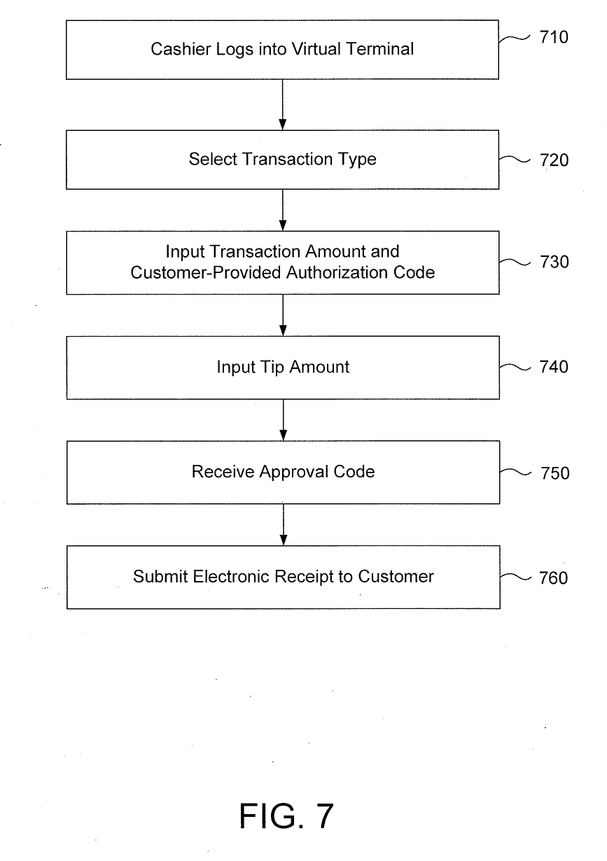

On the opposite side of an electronic transaction is a merchant using a VT. FIG. 7 is a flowchart of a method used by a merchant to process a transaction using a VT. As described above in regards to FIG. 2, a mobile device may be used as a VT once the VT application and a merchantID have been downloaded to the device. Additionally, a merchant may accept and process an electronic transaction, once a cashier associated with the merchant logs into a VT (step 710). As described in FIG. 3, each cashier is provided with a cashierID and a password. Hence, the cashier uses the assigned identifier and password to log into a VT.

Once the cashier has gained access to the VT, the cashier is presented with the option to choose a transaction type. Depending on the position or title of the cashier, the type of transactions he or she may process will vary. In this example, the cashier selects “sale” as the transaction type (step 720). Assuming a customer has already received an authorization code as described in step 540, the cashier inputs the transaction amount and the authorization code (step 730) and submits them to the payment gateway. In one embodiment, the cashier may also submit the merchantID to the payment gateway in order to verify with which merchant the transaction is to be associated. In another embodiment, the merchantID is automatically submitted to the payment gateway by the VT. The merchantID may already be known based on the cashierID used to log into the VT.

Depending on the type of business the merchant provides, providing a tip to the cashier may be appropriate. For example, if the cashier is a wait staff at a restaurant, the customer may wish to add a tip to the total transaction amount. In such a case, the cashier may input the tip amount into the VT (step 740).

Once the transaction amount, authorization code, and optional tip have been submitted, the cashier will receive an approval code from the payment gateway (step 750). The approval code is a guarantee of payment from the payment gateway to the merchant. The approval code functions much like an approval code often displayed on traditional POS terminals when a charge has been approved. In another embodiment, if the transaction amount and the optional tip exceed the balance or credit limit of the financial account selected by the customer, a “transaction denied” message may be received by the VT. In such a case, the transaction may be resubmitted with a reduced tip amount.

Upon completion of the transaction, the cashier transmits an electronic receipt to the customer (step 760) by way of E-Mail, text message or other transmission means know by those skilled in the art. In another embodiment, an electronic receipt may be automatically transmitted to the customer by the payment gateway. Lastly, the cashier logs out of the VT in order to prevent unauthorized access to the VT. In another embodiment, the VT may automatically log the cashier out after a predetermined period of inactivity such as 10 minutes.

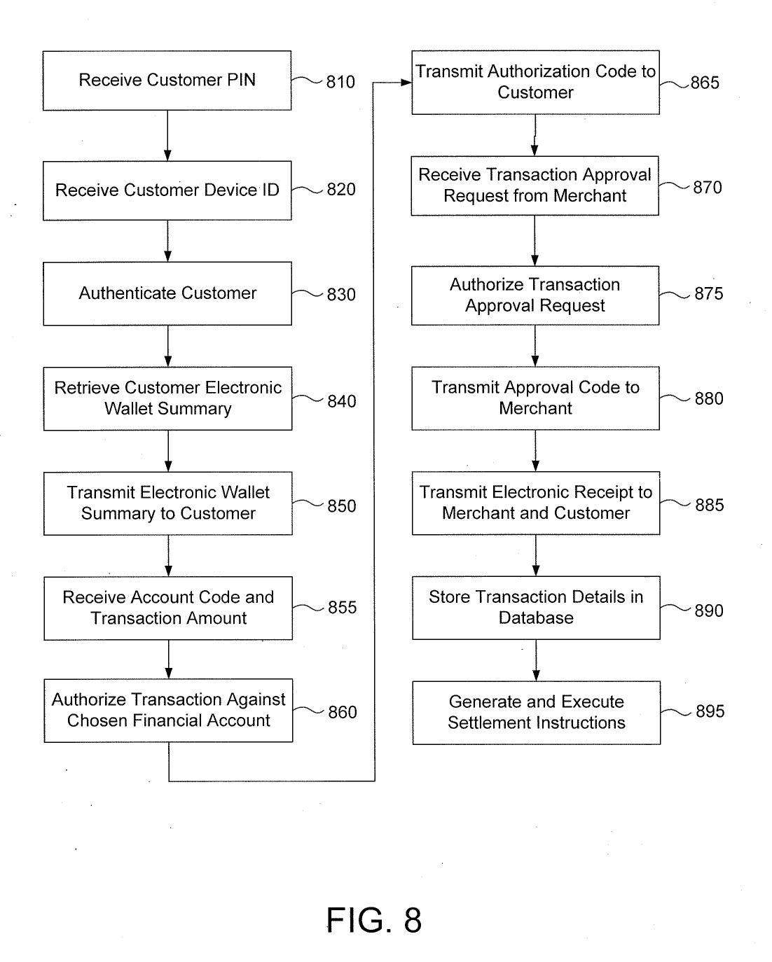

FIG. 8 is a flowchart illustrating a method for processing and settling an electronic transaction from the point of view of the payment gateway. First, the payment gateway receives a PIN from a mobile phone (step 810). Additionally, the deviceID associated with the mobile phone is also received by the payment gateway (step 820). As described in FIG. 4, the deviceID is a unique key identifying the mobile phone from which the ID originated. In one embodiment, both the PIN and deviceID are sent as encrypted files in order to protect their contents during transmission over the Internet.

Upon receipt of the PIN and deviceID, the payment gateway authenticates the customer (step 830). First, the received files are decrypted and their contents are queried against a customer database. If the received PIN matches the PIN stored in the database, the customer is authenticated.

Once authenticated, the payment gateway queries a customer account database to retrieve a listing of the financial accounts (i.e., eWallet summary) linked to the customer's gateway account (step 840). Additionally, the payment gateway queries each financial institution's database to obtain the balance or available credit limit for each of the customer's financial accounts. In order to have access to such financial information of the customer, the payment gateway would have received such authorization from the customer in step 450 above.

Next, the eWallet summary is transmitted to the customer's mobile phone (step 850). As described in FIG. 5, an eWallet summary may contain a listing of each financial account, the balance or available credit limit of each account and a unique account code associated with each account.

Next, the payment gateway receives an account code and a transaction amount from the customer's mobile phone (step 855). The account code is associated with a specific financial account as shown in the eWallet summary. The payment gateway then authorizes the transaction (step 860) by determining if the transaction amount is less than or equal to the balance or available credit limit of the financial account indicated by the account code. If the transaction amount is within the limit, an authorization code is transmitted to the customer's mobile phone (step 865). On the other hand, if the transaction amount is greater than the financial account's balance or available credit, the payment gateway transmits a “transaction declined” message to the customer's mobile phone (not shown). In one embodiment, the authorization code is an encrypted multi-character alphanumeric string with a time sensitive expiration. In other words, the authorization code may be valid for 15 minutes. If the authorization code is not used by a merchant within the time frame, the code becomes invalid. Such measures provide an additional level of security against unauthorized transactions.

If an authorization code was transmitted to the customer's mobile phone, the payment gateway may receive a transaction approval request from a merchant (step 870). As described in step 730, the approval request includes a transaction amount, the authorization code, the merchantID of the merchant, a terminalID of the VT and an optional tip amount. Next, the payment gateway authorizes the approval request (step 875). In one embodiment, the payment gateway combines the transaction amount and the optional tip amount for a total transaction amount. Additionally, the financial institution with which the authorization code is associated is re-queried to verify that the balance or available credit limit is greater than or equal to the total transaction amount. If sufficient funds exist in the customer's financial account, an approval code is transmitted to the merchant's VT (step 880). Optionally, an electronic receipt is generated and transmitted to the customer's mobile phone and/or the merchant's VT (step 885).

In order to maintain transaction history, details of the transaction are stored in a VT transaction database (step 890). In one embodiment, the transaction details stored in the transaction database may include: transaction date and time, deviceID, customer financial account, transaction amount, tip amount, merchantID, cashierID, terminalID, authorization code, and approval code.

Lastly, the payment gateway generates and executes settlement instructions (step 895) with an automated clearing house. Settlement instructions instruct the financial institution associated with a transaction, by way of an automated clearing house, to transfer funds equal to the total transaction amount to the financial institution associated with the merchant who processed the transaction.

In another embodiment, a person or customer associated with a mobile device may use their mobile device and the payment gateway for functionality in addition to wireless payments. A person may also utilize the payment gateway provided authorization code as an authorization of identity. In other words, the payment gateway may return the identity of a person instead of a transaction approval code as described in step 750. For example, a person may enter an establishment requiring a minimum age of 21 for entrance. The person may utilize their mobile phone and the payment gateway to verify his or her identity to the entity requiring proof of age.

In order to provide a person's identity to an entity, the payment gateway would have one or more identification credentials of the person stored in a database. In addition to the customer account creation described in FIG. 4, the person may also provide identification credentials to the payment gateway. Such credentials may include: name, date of birth, age, height, weight, eye color, hair color, gender, a photocopy of one or more official identification card of the person (e.g., driver's license, passport, student ID, etc.) and a picture of the person. In one embodiment, the above credentials may be submitted to the payment gateway by a third party authorization entity in order to prevent fraudulent submission of the information. Once the identification credentials have been submitted and authorized as authentic, the payment gateway may provide this information to an entity having a merchant account and a VT.

FIG. 9 is a flowchart of a method for verifying the identity of a customer to a requesting entity. In regards to FIG. 9 the term “customer” refers a customer of the payment gateway and not necessarily a customer of the entity seeking identification of the payment gateway's customer. First, the payment gateway receives a PIN from a mobile phone associated with the customer (step 910). Additionally, the deviceID associated with the mobile phone is also received by the payment gateway (step 920). As described in FIG. 4, the deviceID is a unique key identifying the mobile phone from which the ID originated. In one embodiment, both the PIN and deviceID are sent as encrypted files in order to protect their contents during transmission over the Internet. Additionally, the payment gateway receives an identity verification request from the mobile phone (step 925). In one embodiment, the identification verification request is a verification PIN known by the customer that alerts the payment gateway that the customer is seeking verification their identity for a requesting entity. As with the customer PIN from step 910, the verification PIN would have been selected during the customer account creation process described in FIG. 4.

Upon receipt of the customer PIN, verification PIN and deviceID, the payment gateway authenticates the customer (step 930). First, the received files are decrypted and their contents are queried against a customer database. If the received PINS match the PINS stored in the database, the customer's PINS are authenticated. Additionally, the deviceID is matched against the deviceID associated with the customer. If a match is found, the customer is authenticated.

Once authenticated, the payment gateway submits an identification authorization code to the customer's mobile phone (step 940). In one embodiment, the authorization identification code is an encrypted multi-character alphanumeric string with a time sensitive expiration. In other words, the authorization code may be valid for 15 minutes. If the authorization code is not used by an entity within the time frame, the code becomes invalid. Such measures provide an additional level of security against unauthorized identification verification.

If an identification authorization code was transmitted to the customer's mobile phone, the payment gateway may receive the same identification authorization code from the requesting entity (step 950). In one embodiment, the requesting entity has a merchant account established with the payment gateway. Additionally, the requesting entity has also registered a VT with the payment gateway as described in FIG. 2. In addition to receiving the identification authorization code from the requesting entity, the payment gateway also receives the merchantID associated with the requesting entity. The payment gateway authenticates the request by querying the customer account database to determine if the received identification authorization code is the same as the identification authorization code described in step 940. If the two codes match and the time limit of the code has not expired, the code is authorized as valid. Additionally, the payment gateway verifies that the received merchantID is valid. If the merchantID is valid, the payment gateway authorizes the identification request (step 955).

Next, the payment gateway queries a customer account database to retrieve the customer identification credentials associated with the identification authorization code (step 960) and submits the credentials to the requesting entity (step 970). Depending on the type of credentials the customer has provided to the payment gateway, a sub-set or the complete set of stored credentials may be transmitted to the requesting entity.

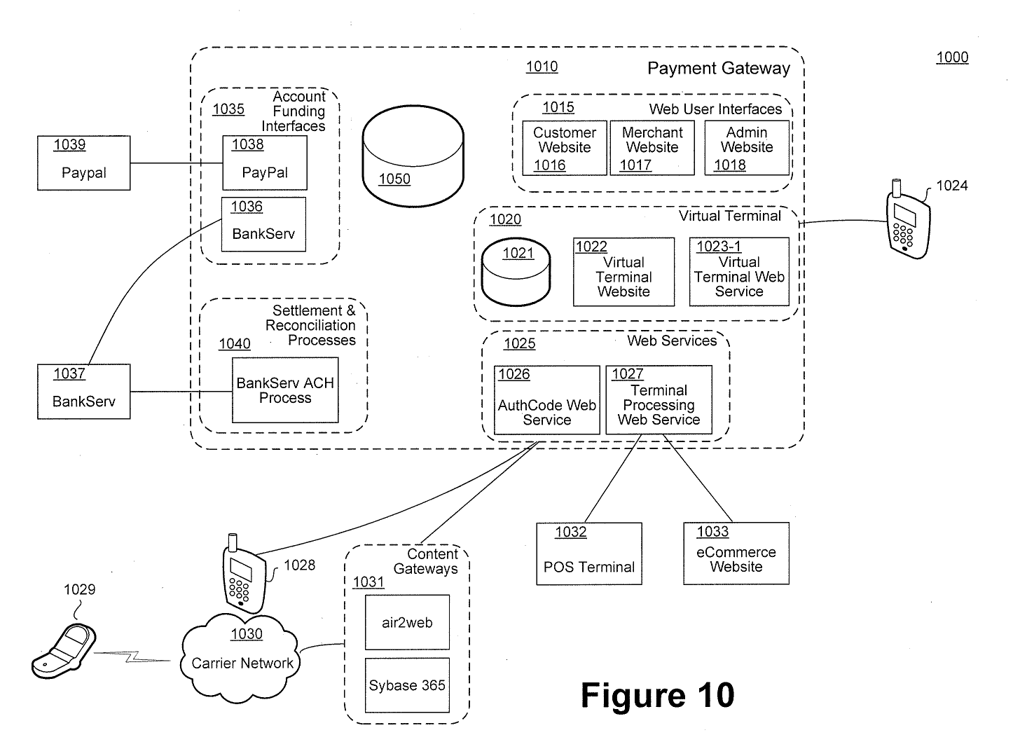

FIG. 10 is a system diagram illustrating an electronic transaction processing system 1000 configured in accordance with one embodiment. At the center of the system 1000 is the payment gateway 1010. As previously stated, the payment gateway 1010 is, in one embodiment, a collection of one or more computer servers. In order to simplify the explanation, the functionality of the payment gateway is shown as a single computer server comprising multiple modules, interfaces and databases. However, in another embodiment, each module, interface and database may comprise one or more computer servers.

Within the payment gateway 1010 are five functional modules, including a web user interface module 1015, a virtual terminal module 1020, a web services module 1025, an account funding interface module 1035, and a settlement and reconciliation module 1040. Beginning with the web user interface module 1015, there are three websites hosted within the module. These include the customer website 1016, the merchant website 1017, and the payment gateway administration website 1018. The customer website 1016 is the same website described in FIG. 4 above. Namely, this is the website a customer accesses in order to establish a new payment account, link or remove existing financial accounts, etc. The merchant website 1017 is the same website described in FIG. 2 above. Hence, the merchant website 1017 is used by merchants to establish a new account or change existing parameters with the account. The payment gateway administration website 1018 is used by personnel of the payment gateway to establish and configure merchantIDs for new and existing merchants. Such functions may include creating new merchantIDs, deleting merchantIDs, and altering existing parameters associated with a merchantID. In one embodiment, the payment gateway administration website 1018 also provides for creating, removing and altering cashierIDs in the same fashion as performed by merchant personnel using the merchant VT administration website as described in FIG. 3. In one embodiment, the websites described in the web user interface module 1010 are Hypertext Preprocessor (“PHP”) enabled websites.

The next functional module of the payment gateway 1010 is the virtual terminal module 1020. The VT module 1020 comprises a VT transaction database 1021, a VT website 1022, and a VT web service 1023. As described in step 883, the VT transaction database 1021 stores details of each electronic transaction processed by a VT. In one embodiment the VT transaction database 1021 is a relational database. The virtual terminal web service 1023 acts as a communication interface between virtual terminal 1024 and the payment gateway 1010. In other words, transmissions between the VT 1024 and the payment gateway 1010 may funnel through the VT web service 1023. Transmissions may include: transaction amounts, merchantIDs, deviceIDs, cashierIDs, authorization codes and approval codes to name a few.

The web services module 1025, which is responsible for processing transactions, includes an authorization code web service 1026 and a terminal processing web service 1027. First, the authorization code web service 1026 provides authorization codes, as described in step 863, to a customer's mobile device 1028. A wireless data-enabled mobile device 1028 is configured to receive HTTPS transmissions directly from the Internet. Alternatively, a standard consumer mobile phone 1029 is also capable of receiving authorization codes. However, a mobile phone 1029 without WI-FI capability depends upon a content gateway 1031 to intercept the authorization code from the authorization code web service 1026 and transmit the code through standard carrier network 1030 to the mobile phone 1029. In one embodiment, a content gateway is a service that transmits text messages, such as SMS, MMS and WAP Push, through standard cellular carrier networks to mobile phones. Examples of a content gateway may include AIR2WEB™ and SYBASE 365™.

As described in related U.S. patent application Ser. No. 11/624,620, the payment gateway 1010 is further capable of processing electronic transactions for merchants that use traditional POS terminals instead of virtual terminals. Terminal processing web service 1027 is configured to communicate with traditional POS terminals 1032 as well as traditional eCommerce websites 1033. In one embodiment, terminal processing web service 1027 communicates with a POS terminal 1032 via dialup connection or over the Internet using the HTTPS protocol. Additionally, terminal processing web service 1027 communicates with an eCommerce website 1033 over the Internet using the HTTPS protocol.

In order for a customer to link an existing financial account to his or her gateway account, the account funding interface module 1035 is used. The account funding interface module 1035 includes one or more account type interfaces. In one embodiment, the account funding interface module 1035 may comprise an account type interface for traditional credit cards, store specific charge cards, checking and savings accounts, and electronic funding services such as PAPAL™. Shown in FIG. 10 is a BankSery interface 1036 and a PAYPAL™ interface 1038. The BankSery interface 1036 is configured to communicate with standard bank checking and savings accounts 1037. In other words, the BankSery interface 1036 is able to receive balance information from such accounts, as well as withdrawal and deposit funds to and from such accounts using a standard ACH. PAYPAL™ interface 1038 is configured to communicate with and directly withdrawal funds from customer PAYPAL™ accounts 1039 without the use of an ACH. Additional interfaces (not shown) may be configured to retrieve balance and credit limit information from traditional credit cards and store specific charge cards.

Additionally, the payment gateway 1010 includes a settlement and reconciliation processes module 1040. In one embodiment, settlement module 1040 comprises a distinct account type interface for each type of financial account described in the account funding interface module 1035. In other words, individual settlement and reconciliation interfaces may exist for standard bank accounts, traditional credit card accounts, store specific charge accounts and electronic payment accounts such as PAYPAL™. BankSery ACH interface 1040 is configured to interface with 3^{rd} party automated clearing houses. Further, interface 1040 is capable of generating and executing settlement instructions for standard bank checking and savings accounts 1037. Additional ACH interfaces (not shown) may exist to generate and execute settlement instructions for PAYPAL™ accounts 1039, traditional credit card accounts and store specific accounts.

In one embodiment, additional financial account types may interface with the payment gateway, such as IRA and 401K accounts, pension accounts, brokerage accounts and others. The exclusion of such accounts is meant to simplify FIG. 10. As such, the account types described in FIG. 10 are meant as examples only and not limiting to the scope of account type coverage.

Lastly, the payment gateway 1010 also includes a payment gateway database 1050. In one embodiment, the payment gateway database 1050 includes multiple databases such as the customer account database described in FIG. 8, the customer identification database described in FIG. 9, and a merchant account database. In another embodiment, the customer account database, the customer identification database, and the merchant account database and others may be stored in separate physical databases. In one embodiment, the payment gateway database 1050 is a relational database.

In conclusion, the present invention provides, among other things, a system and method for processing electronic payment transactions. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A virtual point of sale terminal for initiating and accepting a wireless electronic payment, the apparatus comprising:
a mobile communication device having wireless data communication capabilities, the mobile communication device configured to communicate with a payment gateway system;
a point of sale processing application installed onto the mobile communications device, the point of sale processing application configured to:
wirelessly transmit a request for payment of a transaction to the payment gateway system; and
wirelessly receive an approval code for payment of the transaction from the payment gateway system.

2. The virtual point of sale terminal of claim 1, wherein the point of sale processing application is further configured to:
generate an electronic receipt of the transaction, wherein the electronic receipt includes a summary of the electronic transaction; and
wirelessly transmit the electronic receipt to a customer associated with the transaction.

3. The virtual point of sale terminal of claim 1, wherein the mobile communication device is one of a WI-FI enabled mobile phone, a personal digital assistant, a laptop computer and a desktop computer.

4. An electronic wallet apparatus configured for initiating a wireless electronic payment, the apparatus comprising:
a mobile communication device having wireless data communication capabilities, the mobile communication device configured to communicate with a payment gateway system;
an electronic wallet application installed onto the mobile communication device, the electronic wallet application configured to:
wirelessly transmit a personal identification number to the payment gateway system;
wirelessly receive a financial account summary associated with the mobile communication device from the payment gateway system;
wirelessly transmit a transaction amount and a desired financial account for funding a transaction to the payment gateway system; and
wirelessly receive an authorization code for the transaction from the payment gateway system.

5. The electronic wallet of claim 4, wherein the electronic wallet application is further configured to:
wirelessly receive an electronic receipt of the transaction from one of a virtual terminal associated with a merchant and the payment gateway system.

6. The electronic wallet of claim 4, wherein the financial account summary further comprises:
a listing of financial accounts associated with the mobile communication device;
a listing of balances for each of the listing of financial accounts; and
a listing of account codes corresponding to each of the listing of financial accounts.

7. The electronic wallet of claim 4, wherein the mobile communication device is a WI-FI enabled mobile phone.

8. A method for wirelessly paying for a transaction from an electronic wallet of a mobile communication device, the method comprising:
submitting a personal identification number and a device identifier to a payment gateway system, wherein the personal identification number is associated with the mobile communication device;
receiving a summary of financial accounts from the payment gateway system, wherein the summary of financial accounts is associated with the mobile communication device;
submitting a selected financial account from the summary of financial accounts and a transaction amount to the payment gateway system;
receiving an authorization code from the payment gateway system, wherein the authorization code is associated with a pre-approval for the transaction amount; and
receiving an electronic receipt of the transaction from one of a merchant associated with the transaction and the payment gateway system.

9. The method of claim 8, wherein the summary of financial accounts comprises:
a listing of financial accounts associated with the mobile communication device;
a listing of balances for each of the listing of financial accounts; and
a listing of account codes corresponding to each of the listing of financial accounts.

10. The method of claim 9, wherein the listing of financial accounts comprises:
a first account representative of a bank checking account;
a second account representative of a traditional credit card account; and
a third account representative of store specific charge account.

11. The method of claim 10, further comprising:
submitting the account code associated with the third account to fund the transaction, wherein a store associated with the third bank account is different than a store associated with the merchant.
